(19) United States
(12) Patent Application Publication
(10) Pub. No.: US 2010/0185628 A1
(43) Pub. Date: Jul. 22, 2010

(54) METHOD AND APPARATUS FOR AUTOMATICALLY GENERATING SUMMARIES OF A MULTIMEDIA FILE

(75) Inventors: Johannes Weda, Eindhoven (NL); Marco Emanuele Campanella, Eindhoven (NL); Mauro Barbieri, Eindhoven (NL); Prarthana Shrestha, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/663,529

(22) PCT Filed: Jun. 9, 2008
(86) PCT No.: PCT/IB08/52250

§ 371 Date: Dec. 8, 2009

(30) Foreign Application Priority Data
Jun. 15, 2007 (EP) 07110324.6

(51) Int. Cl. G06F 17/30

(52) U.S. Cl. 707/752; 707/736; 707/E17.044

(57) ABSTRACT

A plurality of summaries of a multimedia file are automatically generated. A first summary of a multimedia file is generated (step 308). At least one second summary of the multimedia file is then generated (step 314). The at least one second summary includes content excluded from the first summary. The content of the at least one second summary is selected such that it is semantically different to the content of the first summary (step 312).

### FIELD OF THE INVENTION

The present invention relates to a method and apparatus for automatically generating a plurality of summaries of a multimedia file. In particular, but not exclusively, it relates to generating summaries of captured video.

### BACKGROUND OF THE INVENTION

Summary generation is particularly useful, for example, to people who regularly capture video. Today, an increasing number of people regularly capture video. This is due to the cheap, easy and effortless availability of video cameras in dedicated devices (such as a camcorders), or video cameras embedded in cell phones. As a result a user's collection of video recordings can become excessively large, making reviewing and browsing increasingly difficult.

However, in capturing an event on video, the raw video material may be lengthy and rather boring to watch. It may be desirable to edit the raw material to show occurrence of major events. Since video is a massive stream of data, it is difficult to access, split, change, extract parts from and merge, in other words, to edit at a “scene” level, i.e. groups of shots naturally belonging together to create a scene. To assist users in a cheap and easy manner, several commercial software packages are available that allow users to edit their recordings.

One example of such a known software package is an extensive and powerful tool known as a non-linear video editing tool that gives the user full control on a frame level. However, the user needs to be familiar with technical and aesthetic aspects of composing desired video footage out of the raw material. Specific examples of such software packages are “Adobe Premiere” and “Ulead Video Studio 9”, which can be found at www.ulead.com/vs.

In using such a software package, the user has full control on the final result. The user is able to select precisely, on frame level, the segments of the video file that are to be included in a summary. The problem with these known software packages is that a high-end personal computer and a fully-fledged mouse-based user interface are needed to perform the editing operations, making editing at frame level intrinsically difficult, cumbersome and time consuming. Furthermore, these programs require a long and steep learning curve and the user is required to be an advanced amateur, or expert, to work with the programs and is required to be familiar with technical and aesthetic aspects of composing a summary.

A further example of a known software package consists of fully automatic programs. These programs automatically generate a summary of the raw material, including and editing parts of the material and discarding other parts. The user has control on certain parameters of the editing algorithm, such as global style and music. However, the problem that exists with these software packages is that the user can only specify global settings. This means that the user has very limited influence on which parts of the material are to be included in the summary. Specific examples of these packages are the “smart movie” function of “Pinnacle Studio”, which can be found at www.pinnaclesys.com, and “Muvee autoProducer”, which can be found at www.muvee.com.

In some software solutions it is possible to select parts of the material, which should definitely end up in the summary, and parts, which should definitely not end up in the summary. However, the automatic editor still has freedom to select out of the remaining parts depending on which parts it considers to be the most convenient. The user is, therefore, unaware which parts of the material have been included in the summary, until the summary is shown. Most importantly, if a user wishes to find out which parts of the video have been omitted from the summary, the user is required to view the entire recording and compare it to the automatically generated summary, which can be time consuming.

A further known system for summarizing a visual recording is disclosed by US 2004/0052505. In this disclosure, multiple visual summaries are created from a single visual recording such that segments in a first summary of the visual recording are not included in other summaries created from the same visual recording. The summaries are created according to an automated technique and the multiple summaries can be stored for selection or creation of a final summary. However, the summaries are created using the same selection technique and contain similar content. The user, in considering the content, which has been excluded, must view all the summaries which is time consuming and cumbersome. Furthermore, since the same selection technique is used to create the summaries, the content of the summaries will be similar and are less likely to contain parts that the user might wish to consider for inclusion in the final summary as it will change the overall content of the originally generated summary.

In summary, the problems with the known systems mentioned above are that they do not give the user easy access, control or an overview of segments excluded from the automatically generated summaries. This is a particular problem for large summary compressions (i.e. summaries that only include a small fraction of the original multimedia file) as the user is required to view all of the multimedia file and compare it to the automatically generated summary in order to determine segments that have been excluded. This forms a difficult and cumbersome problem for the user.

Although the problems above have been mentioned in respect of capturing video, it can be easily appreciated that these problems also exist in generating summaries of any multimedia file such as, for example, photo and music collections.

### SUMMARY OF THE INVENTION

The present invention seeks to provide a method for automatically generating a plurality of summaries of a multimedia file that overcomes the disadvantages associated with known methods. In particular, the present invention seeks to extend the known systems by not only automatically generating a first summary, but also generating a summary of the segments of the multimedia file not included in the first summary. The invention therefore extends the second group of software packages discussed earlier by providing more control and overview to the user, without entering the complicated field of non-linear editing.

This is achieved according to one aspect of the present invention by a method for automatically generating a plurality of summaries of a multimedia file, the method comprising the steps of: generating a first summary of a multimedia file; generating at least one second summary of the multimedia file, the at least one second summary including content excluded from the first summary, wherein the content of the at least one second summary is selected such that it is semantically different to the content of the first summary.

This is achieved according to another aspect of the present invention by apparatus for automatically generating a plurality of summaries of a multimedia file, the apparatus comprising: means for generating a first summary of a multimedia file; and means for generating at least one second summary of the multimedia file, the at least one second summary including content excluded from the first summary, wherein the content of the at least one second summary is selected such that it is semantically different to the content of the first summary.

In this way, the user is provided with a first summary and also at least one second summary including the segments of the multimedia file that were omitted from the first summary. The method for generating a summary of a multimedia file is not merely a general content summarization algorithm, but further enables the generation of a summary of the missing segments of a multimedia file. The missing segments being selected such that they are semantically different to the segments selected for the first summary giving the user a clear indication of the overall content of the file and providing the user with a different view of a summary of the content of the file.

According to the present invention, the content of the at least one second summary may be selected such that it is most semantically different to the content of the first summary. In this way, the summary of the missing segments is such that it focuses on the segments of the multimedia file that mostly differ from the segments included in the first summary, thus the user is provided with a summarized view of a more complete range of the content of the file.

According to one embodiment of the present invention, the multimedia file is divided into a plurality of segments and the step of generating at least one second summary comprises the steps of: determining a measure of a semantic distance between segments included in the first summary and segments excluded from the first summary; including segments in the at least one second summary having a measure of a semantic distance above a threshold.

According to an alternative embodiment of the present invention, the multimedia file is divided into a plurality of segments and the step of generating at least one second summary comprises the steps of: determining a measure of a semantic distance between segments included in the first summary and segments excluded from the first summary; including segments in the at least one second summary having a highest measure of a semantic distance.

In this way, the at least one second summary covers the content excluded from the first summary efficiently, without overloading the user with too many details. This is important if the multimedia file is much longer than the first summary, which means that the number of segments not included in the first summary is much higher than the segments included in the first summary. Furthermore, by including segments in the at least one second summary having a highest measure of a semantic distance the at least one second summary more compact to allow the user efficient and effective browsing and selecting, which takes into account the attention and time capabilities of the user.

The semantic distance may be determined from the audio and/or visual content of the plurality of segments of the multimedia file.

Alternatively, the semantic distance may be determined from the color histograms distances and/or temporal distance of the plurality of segments of the multimedia file.

The semantic difference may be determined from location data, and/or person data, and/or focus object data. In this way, the missing segments can be found by looking for a person, a location and a focus object (i.e. objects taking up a large part of multiple frames) that are not present in the included segments.

According to the present invention, the method may further comprise the steps of: selecting at least one segment of the at least one second summary; and incorporating the selected at least one segment into the first summary. In this way, the user is able to easily select segments of the second summary to be included in the first summary, creating a more personalized summary.

The segments included in the at least one second summary may be grouped such that the content of the segments is similar.

A plurality of second summaries may be organized in accordance with their degree of similarity to the content of the first summary for browsing the plurality of second summaries. In this way, the plurality of second summaries are efficiently and effectively shown to a user.

It is to be noted that the invention can be applied to hard disk recorders, camcorders, video-editing software. Due to its simplicity, the user interface can easily be implemented in consumer products such as hard disk recorders.

### BRIEF DESCRIPTION OF THE DRAWINGS

For a more complete understanding of the invention, reference is made to the following description in conjunction with the accompanying drawings, in which:

FIG. 1 is a flowchart of a known method for automatically generating a plurality of summaries of a multimedia file according to prior art;

FIG. 2 is a simplified schematic of apparatus according to an embodiment of the present invention; and

FIG. 3 is a flowchart of a method for automatically generating a plurality of summaries of a multimedia file according to an embodiment of the present invention.

### DETAILED DESCRIPTION OF EMBODIMENTS OF THE INVENTION

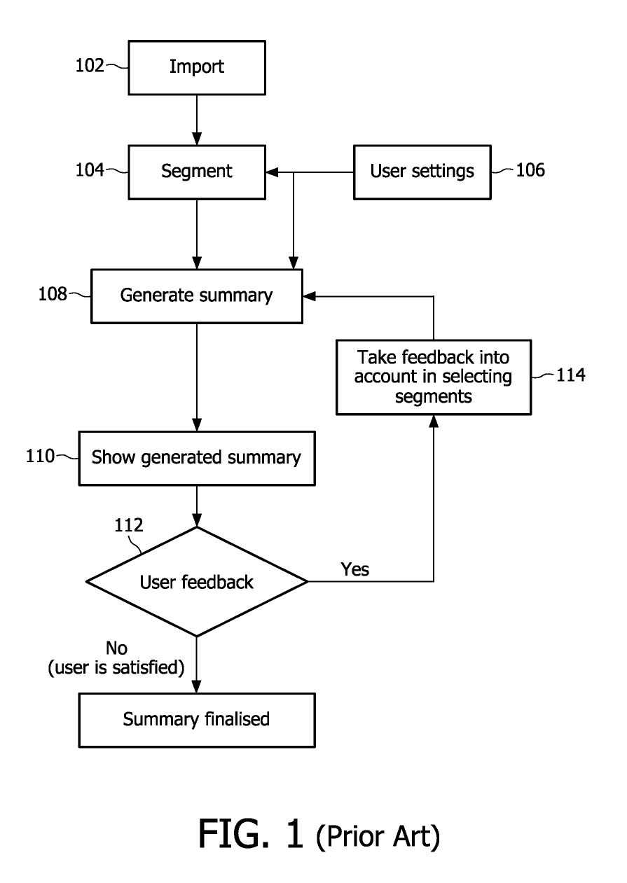

A typical known system for automatically generating a summary of a multimedia file will now be described with reference to FIG. 1.

With reference to FIG. 1, the multimedia file is first imported, step 102.

The multimedia file is then segmented according to features (for example, low-level audiovisual features) extracted from the multimedia file, step 104. The user can set parameters for segmentation, (such as presence of faces and camera motion) and can also manually indicate which segments should definitely end up in the summary, step 106.

The system automatically generates a summary of the content of the multimedia file based on internal and/or user-defined settings, step 108. This step involves selecting segments to include in the summary of the multimedia file.

The generated summary is then shown to the user, step 110. By viewing the summary, the user is able to see which segments have been included in the summary. However, the user has no way of knowing which segments have been excluded from the summary, unless the user views the entire multimedia file and compares it with the generated summary.

The user is asked to give feedback, step 112. If the user provides feedback, the feedback provided is transferred to the automatic editor (step 114) and accordingly, the feedback is taken into account in the generation of a new summary of the multimedia file (step 108).

The problem with this known system is that it does not give the user easy access, control or an overview of segments excluded from the automatically generated summaries. If a user wishes to find out which segments of the video have been omitted from the automatically generated summary, the user is required to view the entire multimedia file and compare it to the automatically generated summary, which can be time consuming.

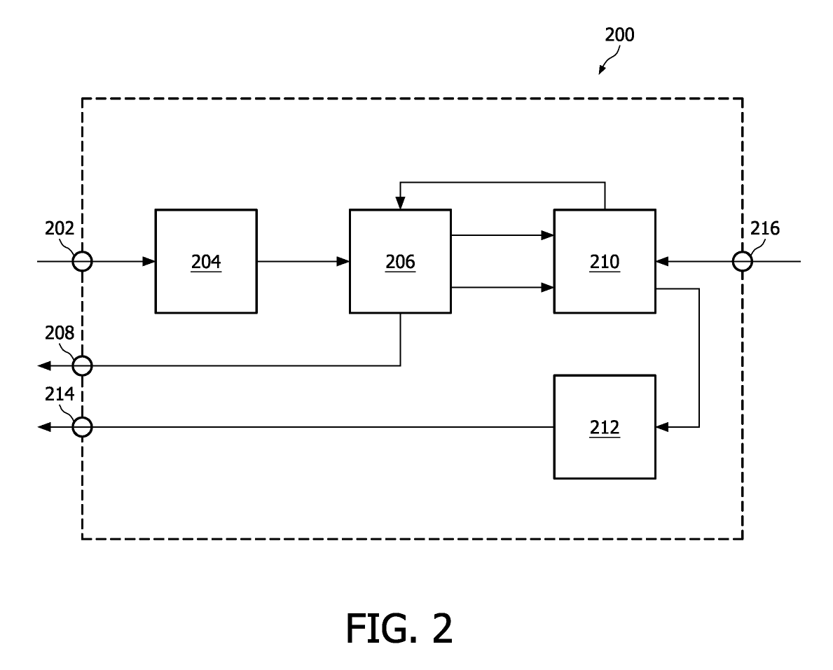

Apparatus for automatically generating a plurality of summaries of a multimedia file according to an embodiment of the present invention will now be described with reference to FIG. 2.

With reference to FIG. 2, the apparatus 200 of an embodiment of the present invention comprises an input terminal 202 for input of a multimedia file. The multimedia file is input into a segmenting means 204 via the input terminal 202. The output of the segmenting means 204 is connected to a first generating means 206. The output of the first generating means 206 is output on the output terminal 208. The output of the first generating means 206 is also connected to a measuring means 210. The output of the measuring means 210 is connected to a second generating means 212. The output of the second generating means 212 is output on the output terminal 214. The apparatus 200 also comprises another input terminal 216 for input into the measuring means 210.

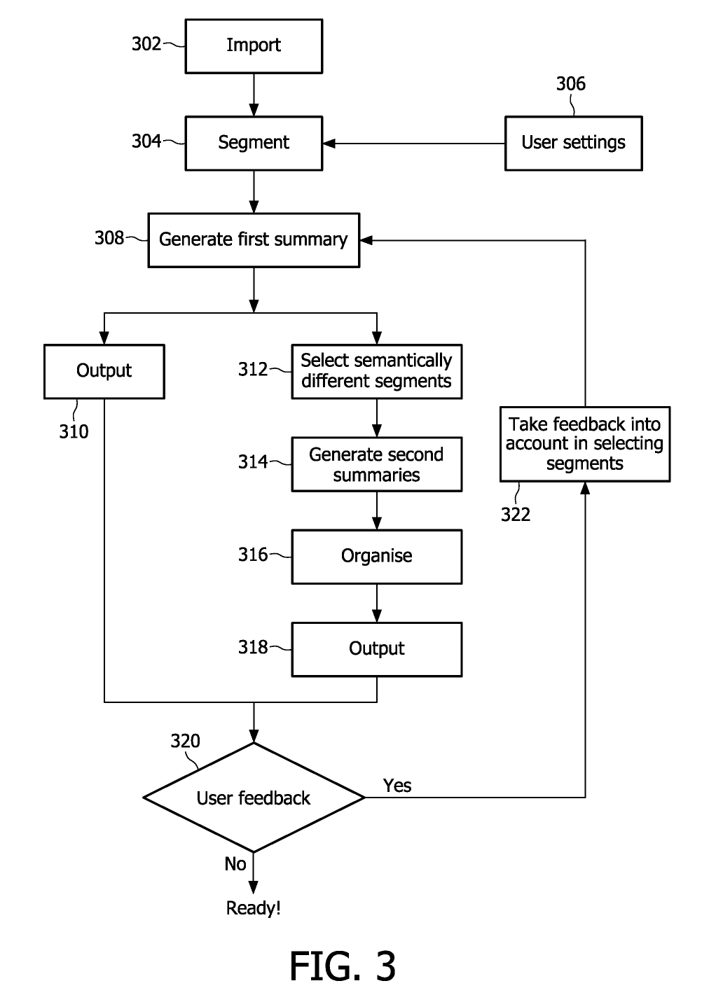

Operation of the apparatus 200 of FIG. 2 will now be described with reference to FIGS. 2 and 3.

With reference to FIGS. 2 and 3, a multimedia file is imported and input on the input terminal 202, step 302. The segmenting means 204 receives the multimedia file via the input terminal 202. The segmenting means 204 divides the multimedia file into a plurality of segments, step 304. A user may, for example, set parameters for segmentation that indicate which segments they wish be included in the summary, step 306. The segmenting means 204 inputs the plurality of segments into the first generating means 206.

The first generating means 206 generates a first summary of the multimedia file (step 308) and outputs the generated summary on the first output terminal 208 (step 310). The first generating means 206 inputs the segments included in the generated summary and the segments excluded from the generated summary into the measuring means 210.

In one embodiment of the present invention, the measuring means 210 determines a measure of a semantic distance between segments included in the first summary and segments excluded from the first summary. The second summary generated by the second generating means 212 is then based on the segments determined to be semantically different from the segments included in the first summary. Therefore, it is possible to establish if two video segments contain correlated or uncorrelated semantics. If the semantic distance between segments included in the first summary and segments excluded from the first summary is determined to be low, the segments have similar semantic content.

The measuring means 210 may determine the semantic distance, for example, from the audio and/or visual content of the plurality of segments of the multimedia file.

Further the semantic distance may be based on location data which may be generated independently, for example, GPS data or from recognition of objects captured by images of the multimedia file. The semantic distance may be based on person data which may be derived automatically from facial recognition of persons captured by images of the multimedia file. The semantic distance may be based on focus object data, i.e. objects which take up a large part of multiple frames. If one or more segments not included in the first summary contain images of a certain location, and/or certain person and/or certain focus object and the first summary does not include other segments that contain images of that certain location, and/or certain person and/or certain focus object, at least one of the one or more segments is preferably included in the second summary.

Alternatively, the measuring means 210 may determine the semantic distance from the color histograms distances and/or temporal distance of the plurality of segments of the multimedia file. In this case, the semantic distance between segments i and j is given by,

D(i,j)=ƒ[D_{C}(i,j),D_{T}(i,j)], (1)

where D(i,j) is the semantic distance between segments i and j, D_{C}(i,j) is the color histograms distance between segments i and j, D_{T}(i,j) is the temporal distance between i and j and ƒ[ ] is an appropriate function to combine the two distances.

The function ƒ[ ] may be given by,

ƒ=w·D_{C}+(1−w)·D_{T}, (2)

where w is a weight parameter.

The output of the measuring means 210 is input into the second generating means 212. The second generating means 212 generates at least one second summary of the multimedia file, step 314. The second generating means 212 generates the at least one second summary such that it includes content excluded from the first summary that was determined to be semantically different to the content of the first summary by the measuring means 210 (step 312).

In one embodiment, the second generating means 212 generates at least one second summary that includes segments having a measure of a semantic distance above a threshold. This means that only segments that have uncorrelated semantic content with the first summary are included in the second summary.

In an alternative embodiment, the second generating means 212 generates at least one second summary that includes segments having a highest measure of a semantic distance.

For example, the second generating means 212 may group the segments excluded from the first summary into clusters. Then, a distance δ(C,S) between a cluster C and the first summary S is given by,

δ(C,S)=min_{i∈S}(D(c,i)) (3)

where i is each segment included in the first summary S and c is the representative segment for cluster C. The distance δ(C,S) may be given by other functions, such as

$$δ ( C , S ) = {\sum }_{i ∈ S} D ( c , i )$$

or, δ(C,S)=ƒ[D(c,i)], i ∈ S where ƒ[ ] is an appropriate function. The second generating means 212 uses the distance δ(C,S) to rank the clusters of the segments excluded from the first summary on the basis of the semantic distance they have with the first summary S. Then, the second generating means 212 generates at least one second summary that includes segments having a highest measure of a semantic distance (i.e. segments that differ the most from the segments of the first summary).

According to another embodiment, the second generating means 212 generates at least one second summary that includes segments having similar content.

For example, the second generating means 212 may generate the at least one second summary using a correlation dimension. In this case, the second generating means 212 positions the segments on a correlation scale according to their correlation with the segments included in the first summary. The second generating means 212 could then identify segments that are very similar, rather similar, or totally different from the segments included in the first summary and thus generates at least one second summary according to a degree of similarity selected by the user.

The second generating means 212 organizes the second summaries in accordance with their degree of similarity to the content of the first summary for browsing the plurality of second summaries, step 316.

For example, the second generating means 212 may cluster the segments excluded from the first summary and organize them according to the semantic distance between segments D(i,j), (as defined, for example, in equation (1)). The second generating means 212 may cluster segments that are close to each other according to a semantic distance such that each cluster contains segments having the same semantic distance. The second generating means 212 then outputs the most relevant clusters with respect to the degree of similarity specified by the user on the second output terminal 214, step 318. In this way, the user is not required to browse a large number of second summaries, which would be cumbersome and time consuming. Examples of clustering techniques can be found in “Self-organizing formation of topologically correct feature maps”, T. Kohonen, Biological Cybernetics 43(1), pp. 59-69, 1982 and “Pattern Recognition Principles”, J. T. Tou and R. C. Gonzalez, Addison-Wesley Publishing Co, 1974.

Alternatively, the second generating means 212 may cluster and organize the segments in a hierarchical way such that the main clusters contain other clusters. The second generating means 212 then outputs the main clusters on the second output terminal 214 (step 318). In this way, the user only has to browse a small number of main clusters. Then, if they desire, the user can explore each of the other clusters in more and more detail with a few interactions. This makes browsing a plurality of second summaries very easy.

The user is able to view the first summary output on the first output terminal 208 (step 310) and the at least one second summary output on the second output terminal 214 (step 318).

Based on the first summary output on the first output terminal 208 and the second summary output on the second output terminal 214, the user can provide feedback via the input terminal 216, step 320. For example, the user may review the second summary and select segments to be included in the first summary. The user feedback is input into the measuring means 210 via the input terminal 216.

The measuring means 210 then selects at least one segment of the at least one second summary such that the feedback of the user is taken into account, step 322. The measuring means 210 inputs the selected at least one segment into the first generating means 206.

The first generating means 206 then incorporates the selected at least one segment into the first summary (step 308) and outputs the first summary of the first output terminal 208 (step 310).

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for automatically generating a plurality of summaries of a multimedia file, the method comprising the steps of:
generating a first summary of a multimedia file;
generating at least one second summary of said multimedia file, said at least one second summary including content excluded from said first summary, wherein the content of said at least one second summary is selected such that it is semantically different to the content of said first summary.

2. A method according to claim 1, wherein the content of said at least one second summary is selected such that it is most semantically different to the content of said first summary.

3. A method according claim 1, wherein said multimedia file is divided into a plurality of segments and the step of generating at least one second summary comprises the steps of:
determining a measure of a semantic distance between segments included in said first summary and segments excluded from said first summary;
including segments in said at least one second summary having a measure of a semantic distance above a threshold.

4. A method according claim 1, wherein said multimedia file is divided into a plurality of segments and the step of generating at least one second summary comprises the steps of:
determining a measure of a semantic distance between segments included in said first summary and segments excluded from said first summary;
including segments in said at least one second summary having a highest measure of a semantic distance.

5. A method according to claim 1, wherein the steps of generating said first and second summaries are based upon audio and/or visual content of said plurality of segments of said multimedia file.

6. A method according to claim 3, wherein the semantic distance is determined from the color histograms distances and/or temporal distance of said plurality of segments of said multimedia file.

7. A method according to claim 3, wherein the semantic distance is determined from location data, and/or a person data, and/or focus object data.

8. A method according to claim 1, wherein the method further comprises the steps of:
selecting at least one segment of said at least one second summary; and
incorporating said selected at least one segment into said first summary.

9. A method according to claim 3, wherein segments included in said at least one second summary have similar content.

10. A method according to claim 1 wherein a plurality of second summaries are organised in accordance with their degree of similarity to the content of said first summary for browsing said plurality of second summaries.

11. A computer program product comprising a plurality of program code portions for carrying out the method according to claim 1.

12. Apparatus for automatically generating a plurality of summaries of a multimedia file, the apparatus comprising:
means for generating a first summary of a multimedia file; and
means for generating at least one second summary of said multimedia file, said at least one second summary including content excluded from said first summary, wherein the content of said at least one second summary is selected such that it is semantically different to the content of said first summary.

13. Apparatus according to claim 12, wherein the apparatus further comprises:
segmenting means for divided said multimedia file into a plurality of segments;
determining a measure of a semantic distance between segments included in said first summary and segments excluded from said first summary;
including segments in said at least one second summary having a measure of a semantic distance above a threshold.
